(19) United States
(12) Patent Application Publication
(10) Pub. No.: US 2023/0136145 A1
(43) Pub. Date: May 4, 2023

(54) METHOD FOR PRODUCING A SCREW, AND SCREW

(71) Applicant: EJOT SE & Co. KG, Bad Berleburg (DE)

(72) Inventors: Ralph J. HELLMIG, Bad Laasphe (DE); Michael ACHENBACH, Breidenbach (DE); Fabian SIMONSEN, Erfurt (DE)

(21) Appl. No.: 17/910,917

(22) PCT Filed: Mar. 16, 2021
(86) PCT No.: PCT/EP2021/056712

§ 371 Date: Sep. 12, 2022

(30) Foreign Application Priority Data
Mar. 16, 2020 (DE) 10 2020 107 194.9

(51) Int. Cl. C21D 1/78; C21D 1/20; C21D 9/00

(52) U.S. Cl. CPC C21D 1/785; C21D 1/20; C21D 9/0093; C21D 2211/002; C21D 2211/001; C21D 2211/008

(57) ABSTRACT

The invention relates to a method for producing a screw, having the following steps: (a) rolling a screw wire made of low-alloy carbon steel to produce screw (10) having a thread; (b) heating the entire screw (10) to an austenitizing temperature under a carbon atmosphere and/or nitrogen atmosphere and maintaining the temperature; (c) quenching the entire screw (10) to a bainitizing temperature and maintaining the bainitizing temperature until the screw has a bainitic structure over its cross-section. The invention is characterized in that the screw (10) is subsequently hardened locally at its tip (22), by the tip (22) being heated to an austenitizing temperature and the screw (10) being subsequently quenched to a temperature below the martensite starting temperature (MS).

The present application is a National Stage application of PCT international application: PCT/EP2021/056712 filed on Mar. 16, 2021, which claims the benefit of priority from the German Patent Application No. 10 2020 107 194.9, filed on Mar. 16, 2020, both the disclosures of which are hereby incorporated by reference in their entireties.

The invention relates to a method for producing a screw, as specified in the preamble of claim 1, as well as to a screw for direct fastening, as specified in the preamble of claim 5.

EP 3 276 189 A1 describes a screw that has a softer bainitic structure in its edge region along the screw shaft as compared to the screw core. DE 10 2017 101 931 A1 discloses a screw having a bainitic structure in which the bainitic structure is of a lower hardness in the axial direction in the tip of the screw than in a central region located in the direction of the head of the screw.

DE 10 2010 055 210 A1 discloses a method for producing a screw with a double-hardened tip which tip has a higher carbon content than the tempered martensitic shaft region of the screw. As a result, the shaft with the holding region of its thread is less prone to hydrogen embrittlement than the hardened tip of the screw. For this purpose, the tip of a low-alloy carbon screw is partially carburized, then the entire screw is tempered, and subsequently the tip is hardened again locally.

This method is complex and cost-intensive due to the partial carburizing of the screw.

It is the object of the invention to provide a faster and/or more efficient method for producing a screw which method achieves a particularly high degree of hardness in the tip of the screw, and yet a lower degree of hardness in the shaft with its head and holding region, thus making the shaft comparatively less prone to hydrogen embrittlement. The expression ‘tip’ in the sense of the invention is understood to mean a front region of the screw which extends from the foremost end of the screw in the direction of the screw head. Preferably, this is a region designed to tap a female thread into a female piece which in particular consists of high-strength metallic materials.

The screw according to the invention is manufactured by forming a screw from a low-alloy carbon steel wire that in particular has an alloy content of less than 3% of alloying elements. The thread is rolled onto the screw during manufacture of the latter. The material used for the screw wire is preferably 23MnB4 or 38B2.

The screw is then heated to an austenitizing temperature, with the austenitizing temperature being a temperature at which the respective wire material used is in the austenite phase field of its TTT diagram. In particular, the austenizing temperature is higher than the A₃ temperature of the wire material.

After heating the screw to the austenitizing temperature, the screw is quenched to a bainitizing temperature, which temperature is maintained until the screw has a bainitic structure, in particular over the cross-section of the screw shaft. The bainitizing temperature is a temperature at which the wire material is in the bainite phase field. In particular, the quenching time is selected so as to prevent both ferrite and pearlite formation during the quenching process. Quenching is carried out in particular by immersing the screws in a molten salt bath at a bainitizing temperature. A bainite-containing structure is present if a structural section under consideration has a significant and measurable bainite content of in particular more than 25%. A structural section preferably has a size of 0.05 mm².

In the screw according to the invention, the total area of the structural sections having a bainite content of more than 25% accounts for a surface area proportion of in particular more than 80% of the cross-sectional area of the screw.

According to the invention, after the screw has been kept at a bainitizing temperature for a defined period of time, it is cooled down to below the martensite starting temperature, in particular to room temperature, after which the tip of the screw is heated again locally to an austenitizing temperature. At least the tip of the screw is then quenched again to below the martensite starting temperature, with the quenching time being selected such that ferrite, pearlite and bainite formation is largely prevented.

This results in the tip being hardened again locally, particularly in its edge zone, which means that an ultra-hard tip can be provided.

This ensures that a screw produced according to the invention has low proneness to hydrogen embrittlement in the shaft, but can still have an ultra-hard tip.

According to a preferred embodiment of the invention, heating of the screw to an austenitizing temperature before quenching the screw to a bainitizing temperature can be carried out in a carbon atmosphere having a carbon content higher than the carbon content of the screw, so that a layer is formed in the edge zone of the screw that has a higher carbon content than the core, resulting in a carbon content in the edge zone of the screw that is at least 0.2% higher than in the core zone of the screw. Alternatively, so-called nitriding of the screw can be carried out in a similar way. This is particularly useful for wire materials which have a carbon content of less than 0.4%.

This process, in which carbon or nitrogen is introduced into the screw at austenitizing temperature, followed by quenching to bainitizing temperature, is referred to below as case-hardening bainitizing. A structure produced in this way is referred to as a case-hardened bainitic structure.

Thus, the screw manufactured in this way can have a case-hardened bainitic structure in its shaft and its head region, in particular in the edge zone, and an ultra-hard martensitic structure in its tip, in particular in the edge zone of its tip. In particular, the edge zone has a carbon content of between 0.6% and 1.5%.

For direct fastening, the screw according to the invention thus exhibits both a high degree of hardness in its tip and a high degree of ductility in its shaft, which latter moreover exhibits low proneness to hydrogen embrittlement.

According to a further embodiment of the invention, the screw can be tempered after case-hardening bainitizing and after hardening of the tip.

Preferably, the tempering process may be performed together with a coating process. In particular, the coating may be zinc flake coating.

In another aspect thereof, the invention relates to a screw having a shaft comprising the screw head and a tip comprising the opposite end of the screw, wherein the shaft has a substantially bainitic structure over its cross-section and, according to the invention, the screw has a tip with a martensitic edge zone.

In particular, the edge zone has a higher carbon content than the core, with the difference in concentration being at least 0.2%.

The shaft may have a substantially tempered bainitic structure in its core and a tempered structure in its edge zone, which latter structure has a higher carbon content than the core. The tip may have a tempered hardened martensitic structure at least in its edge zone.

The screw according to the invention is preferably produced using the method described above.

Additional advantages, features and possible applications of the present invention will become apparent from the following description in which reference is made to the embodiments illustrated in the drawings.

In the drawings,

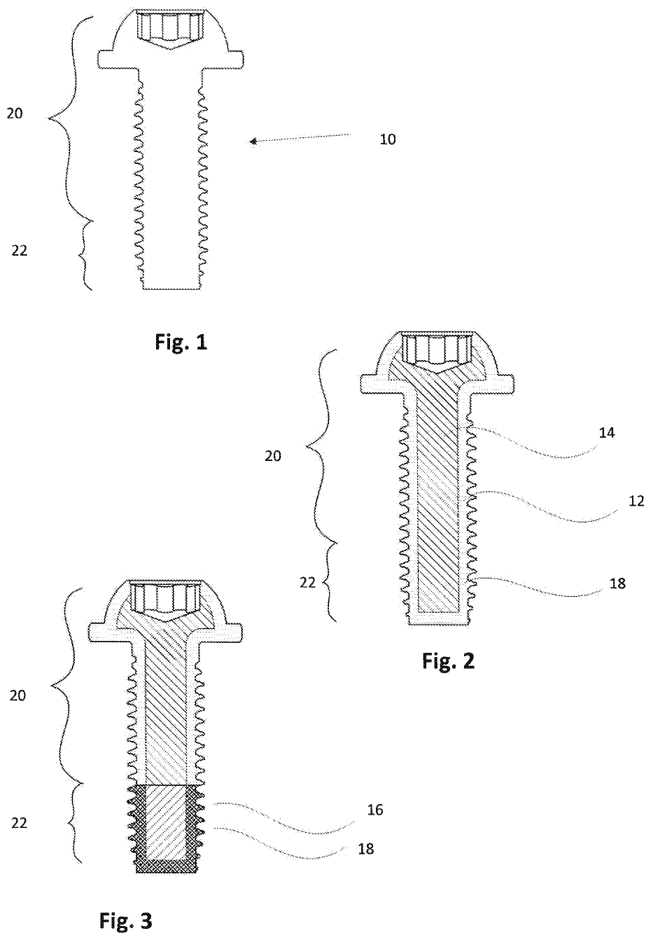

FIG. 1 is a schematic sectional view of a low-alloy carbon steel screw manufactured by rolling the screw thread onto the shaft;

FIG. 2 is a schematic sectional view of the screw after case-hardening bainitizing;

FIG. 3 is a schematic sectional view of the screw after local case hardening of the tip;

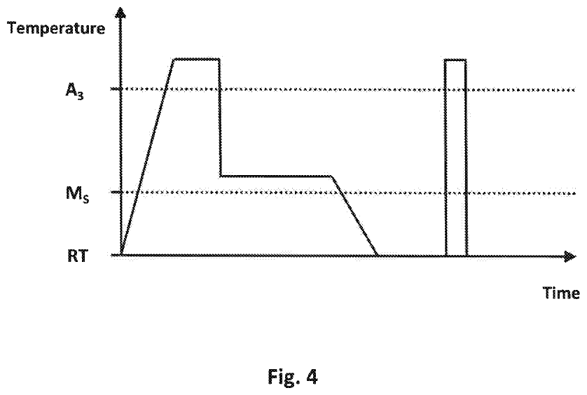

FIG. 4 is a schematic temperature-time diagram of the method according to the invention for producing the screw and case hardening of the tip.

FIG. 1 is a schematic sectional view of a rolled screw 10 made of conventional screw steel after a process step. The screw has a shaft 20 comprising the screw head and a free screw end which is referred to here as the tip 22 and is located opposite the head in the axial direction. The screw according to the invention is manufactured by forming, in a process step, the screw from a screw wire of low-alloy carbon steel having an alloy content of less than 3% of alloying elements. Manufacture of the screw in particular involves rolling the thread onto the screw. Preferably, 23MnB4 is used as the material for the screw wire. This kind of steel can be processed well in a rolling process.

FIG. 2 is a schematic sectional view of the screw 10.

To achieve the state illustrated in FIG. 2, the screw 10 was heated to an austenitizing temperature in a carbon atmosphere having a higher carbon content than the screw 10 itself and exposed to this carbon atmosphere until a carbon content was reached in the edge zone 12 of the shaft and in the edge zone 18 of the tip of the screw 10 which is at least 0.2% higher than that in the core of the screw, and which in particular is between 0.6% and 1.5%. In the present view, edge zone 12 and edge zone 18 are only schematically illustrated and may vary in depth. As an alternative or in addition to carburizing, nitriding can also take place analogously.

After reaching the desired carbon saturation in edge zone 12 and edge zone 18, the screw 10 is quenched, in particular in a molten salt bath, to a bainitizing temperature, which bainitizing temperature is above the martensite starting temperature Ms. The screw is kept at bainitizing temperature until its shaft substantially has a bainitic structure 14 over its cross-sectional area. The screw 10, according to FIG. 2, has a higher carbon content in edge layer 12 and edge layer 18 than the core. A substantially bainitic structure is defined as at least 80% of the cross-sectional area having a bainitic structure. Other structures may also be present in some cases.

FIG. 3 is a schematic sectional view of a screw 10 according to the invention, in which the tip 22 of the screw has been heated again locally to an austenitizing temperature and then cooled down to a temperature below the martensite starting temperature Ms to form martensite, so that a hardened martensitic microstructure 16 with a carbon content of about 1% is present in the tip 22, in particular in the edge layer 18. This results in the creation of an ultra-hard tip.

FIG. 4 is a schematic temperature-time diagram of the manufacturing method according to the invention. The screw is first heated to an austenitizing temperature that is higher than the A₃ temperature. If the wire material does not have a sufficient carbon content of between 0.6% and 1.5%, such heating can be performed in a carbon enriching atmosphere. The carbon content of the atmosphere has a higher carbon concentration than the wire material, so that carbon will diffuse from the carbon atmosphere into the edge zone of the screw during heating.

The screw is then quenched to a bainitizing temperature. The bainitizing temperature is the temperature at which the wire material is in the bainite phase field of its time-temperature diagram. The quenching time is selected to prevent both ferrite and pearlite formation during the quenching process. The screw is held at the bainitizing temperature until substantial portions of the cross-section of the screw exhibit a bainite structure. The screw is then cooled down to room temperature.

After the screw manufactured in this way has been cooled down to room temperature RT, its tip is locally reheated to an austenitizing temperature and then quenched again to below the martensite starting temperature Ms so that a martensitic structure is formed at least in the edge zone of the tip.

1. A method for producing a screw, comprising the following steps:
rolling a screw wire made of low-alloy carbon steel to produce a screw having a thread;
heating the entire screw to an austenitizing temperature under a carbon atmosphere and/or nitrogen atmosphere and maintaining the temperature;
quenching the entire screw to a bainitizing temperature and maintaining the bainitizing temperature until the screw has a bainitic structure over a cross-section thereof, wherein
the screw is subsequently hardened locally at a tip thereof, the tip being heated to an austenitizing temperature and the screw being subsequently quenched to a temperature below a martensite starting temperature Ms.

2. A method according to claim 1, wherein the carbon atmosphere has a higher carbon content than the screw and/or that the nitrogen atmosphere has a higher nitrogen content than the screw.

3. A method according to claim 1, wherein the screw is kept at an austenitizing temperature in the carbon atmosphere until an edge zone of the screw has a carbon content which is at least 0.2% higher than a carbon content of a core thereof.

4. A method according to claim 1, wherein the screw is tempered.

5. A screw comprising a thread-bearing shaft and a tip, the shaft having a substantially bainitic structure in a core thereof, wherein the tip substantially consists of a hardened martensitic structure, at least in an edge zone thereof.

6. A screw according to claim 5, wherein in the edge zone, the screw has a structure with a higher carbon content than that of a core thereof.

7. A screw according to claim 5, characterized in that in its core, the shaft has a substantially tempered bainitic structure, and in its edge zone, the shaft has a tempered structure with a higher carbon content than that of the core, with the tip having a tempered hardened martensitic structure, at least in its edge zone.

8. A screw according to claim 5, wherein the screw is produced using a method comprising the steps of rolling a screw wire made of low-alloy carbon steel to produce a screw having a thread; heating the entire screw to an austenitizing temperature under a carbon atmosphere and/or nitrogen atmosphere and maintaining the temperature; quenching the entire screw to a bainitizing temperature and maintaining the bainitizing temperature until the screw has a bainitic structure over a cross-section thereof, wherein the screw is subsequently hardened locally at a tip thereof, the tip being heated to an austenitizing temperature and the screw being subsequently quenched to a temperature below a martensite starting temperature Ms.

9. A screw according to claim 8, wherein the carbon atmosphere has a higher carbon content than the screw and/or that the nitrogen atmosphere has a higher nitrogen content than the screw.

10. A screw according to claim 8, wherein the screw is kept at an austenitizing temperature in the carbon atmosphere until an edge zone of the screw has a carbon content which is at least 0.2% higher than a carbon content of a core thereof.

11. A screw according to claim 8, wherein the screw is tempered.
